(19) United States
(12) Patent Application Publication
(10) Pub. No.: US 2023/0075611 A1
(43) Pub. Date: Mar. 9, 2023

(54) RETRACTABLE DOOR SILL

(71) Applicant: GUANGZHOU TUSUNNY HOME PRODUCTS CO., LTD, Guangzhou (CN)

(72) Inventor: Hongjuan WANG, Guangzhou (CN)

(21) Appl. No.: 17/987,719

(22) Filed: Nov. 15, 2022

Related U.S. Application Data
(62) Division of application No. 17/392,266, filed on Aug. 3, 2021.

(30) Foreign Application Priority Data
Jun. 25, 2021 (CN) 202110712660.2
Jul. 19, 2021 (CN) 202110814773.3

(51) Int. Cl. E06B 9/60; E06B 9/90

(52) U.S. Cl. CPC E06B 9/60; E06B 9/90; E06B 2009/801

(57) ABSTRACT

A retractable door sill, including: a mounting base, the mounting base including an upper fixing base and a lower fixing base; a rotating drum, the rotating drum being arranged between the upper fixing base and the lower fixing base, a partition cloth, a torsion spring being configured to make the rotating drum rotate in one direction around its axis, the rotating drum wind up the partition cloth; and an adjusting device, the adjusting device comprising an adjusting rod and an adjusting mechanism, one end of the torsion spring being connected to the rotating drum, the other end of the torsion spring being connected to the adjusting rod of the adjusting device, the adjusting mechanism being configured to enable the adjusting rod to rotate unidirectionally around its own axis, and the adjusting rod being configured to change a torsional deformation of the torsion spring through its own rotation.

### TECHNICAL FIELD

The present disclosure relates to the technical field of door sills, and in particular, to a retractable door sill.

### BACKGROUD

Retractable door sills are mostly used indoors or in courtyards, and are used to separate indoor spaces or courtyard spaces, so as to form different temporary activity spaces indoors or in courtyards. Specifically, the retractable door sill includes a rotating drum and a partition cloth, an end of the partition cloth is arranged on the rotating drum, and a torsion spring is arranged in the rotating drum. A rotational elastic force of the torsion spring can make the rotating drum rotate in one direction around an axis of the rotating drum, and thus the rotating drum can wind up the partition cloth. When the retractable door sill is actually used, the partition cloth is pulled out of the rotating drum by hand by a certain length and then a pulled-out end of the partition cloth is fixed, and the torsion spring always applies force on a partition cloth section pulled out. The partition cloth is kept in a tight state, and the tight partition cloth forms a partition barrier to complete space partition. When the pulled-out end of the partition cloth is unlocked by hand, the partition cloth is rewound on the rotating drum under the action of the torsion spring, which can remove space partition. It can be seen from the actual use of the retractable door sill that when the partition cloth is pulled out from the rotating drum by hand, the rotational elastic force of the torsion spring needs to overcome. However, different users have different hand strengths. It may be easier for male users to pull out the partition cloth from the rotating drum, but it may be more difficult for female users. In addition, after the retractable door sill is used for many times, the rotational elastic force of the torsion spring will decrease. The decrease of the elastic force will cause the partition cloth to enter a relaxed state from a tight state, and the partition cloth in the relaxed state cannot form an upright partition barrier to achieve space partition. An existing retractable door sill is implemented by only setting a torsion spring to a certain torsional deformation and then placing the torsion spring into a rotating drum (for a method for using a standard part of a torsion spring reference may be made to the patent CN 103225477 A titled NON-RETURN SUNSHADE BLIND). A user cannot actively adjust a torsional deformation of the torsion spring during the use of the retractable door sill, i.e., the user cannot actively adjust a rotational elastic force of the torsion spring according to his/her own needs when actually using the retractable door sill, so that the user experience is poor. Therefore, it is necessary to make an improvement on the prior art to solve the above-mentioned technical problems.

### SUMMARY

A main objective of the present disclosure is to provide a retractable door sill. The actual technical problem to be solved by the present disclosure is how to actively adjust a rotational elastic force of a torsion spring according to a user's own needs so as to improve user experience.

To achieve the above-mentioned objective, the present disclosure provides the retractable door sill, including:

a mounting base;

the mounting base including an upper fixing base and a lower fixing base;

a rotating drum, the rotating drum being arranged between the upper fixing base and the lower fixing base, and the rotating drum being configured to rotate around its own axis;

a partition cloth, an end of the partition cloth being arranged on the rotating drum;

a torsion spring being arranged in the rotating drum, and the torsion spring being configured to make the rotating drum rotate in one direction around its axis, so that the rotating drum can wind up the partition cloth; and

a support rod parallel to the rotating drum is arranged between the upper fixing base and the lower fixing base, and a movable fixing base is arranged at the support rod; the movable fixing base can move back and forth in the length direction of the support rod.

Further, the retractable door sill further includes an adjusting device, the adjusting device including an adjusting rod and an adjusting mechanism, one end of the torsion spring being connected to the rotating drum, the other end of the torsion spring being connected to the adjusting rod of the adjusting device, the adjusting mechanism being a unidirectional rotating mechanism, the adjusting mechanism being configured to enable the adjusting rod to rotate unidirectionally around its own axis, and the adjusting rod being configured to drive the torsion spring to twist through its own unidirectional rotation to complete the compression of the torsion spring so as to increase the torsional deformation of the torsion spring.

Further, the adjusting mechanism includes:

an adjusting ratchet;

the adjusting ratchet being connected to the adjusting rod;

an adjusting pawl matched with the adjusting ratchet, the lower fixing base being provided with an installation cavity, the adjusting ratchet and the adjusting pawl being arranged in the installation cavity, the adjusting ratchet being configured to be rotatable around its own axis, a rotating rod being convexly arranged on the lower fixing base, and the adjusting pawl sleeving the rotating rod through a through hole formed in the adjusting pawl; and

a first abutment spring, the first abutment spring being configured to push the adjusting pawl to maintain a tendency of inserting into a tooth groove in the adjusting ratchet.

Further, an outer side face of the adjusting ratchet is provided with an adjusting groove.

Further, an unlocking part is convexly arranged on a side of the adjusting ratchet, and configured to drive the adjusting pawl to be separated from the tooth groove in the adjusting ratchet after being pushed.

Further, a lower end face of the lower fixing base is provided with a sealing cover for sealing the installation cavity, and the sealing cover is provided with a window hole for making the unlocking part visible.

Further, the retractable door sill further includes a locking device, where the locking device is arranged in the upper fixing base, and includes:

a locking ratchet;

the locking ratchet being connected to an upper end of the rotating drum;

a locking pawl matched with the locking ratchet, a rotating shaft being convexly arranged on the upper fixing base, and the locking pawl sleeving the rotating shaft through a through hole formed in the locking pawl; and

a second abutment spring, the second abutment spring being configured to push the locking pawl to maintain a tendency of inserting into a tooth groove in the locking ratchet.

Further, the locking device further includes an unlocking assembly, where

the unlocking assembly includes a pushing-away turntable and a pushing-away convex portion arranged on a side of the pushing-away turntable, and the pushing-away turntable is configured to be rotatable around its own axis; and

a pushed-away part is convexly arranged on the locking pawl, the pushing-away convex portion is configured to be driven to rotate around the axis of the pushing-away turntable, so that the pushing-away convex portion pushes the pushed-away part to make the pushed-away part rotate around an axis of the rotating shaft, and thus the locking pawl is driven by the pushed-away part to be separated from the tooth groove in the locking ratchet.

Further, the upper fixing base is provided with a protective shell, the protective shell is provided with a placing cavity capable of accommodating a locking knob, and the locking knob is connected to the pushing-away turntable.

Further, a pull-out end cover of the partition cloth is provided with a protecting shell, the protecting shell is provided with a corner wrapping part, and the corner wrapping part is configured to wrap a corner of a pulled-out end of the partition cloth.

Further, the rotating drum is provided with a fixing groove, a length direction of the fixing groove is flush with the axis of the rotating drum, a plastic strip is connected to an end of the partition cloth arranged on the rotating drum, and the plastic strip is clamped in the fixing groove.

Compared with the prior art, the present disclosure has the following beneficial effects:

The present disclosure is provided with an adjusting device, the adjusting device includes an adjusting rod and an adjusting mechanism, one end of the torsion spring is connected to the rotating drum, the other end of the torsion spring is connected to the adjusting rod of the adjusting device, the adjusting mechanism is configured to enable the adjusting rod to rotate unidirectionally around its own axis, and the adjusting rod changes a torsional deformation of the torsion spring through rotation. A user can actively adjust the torsional deformation of the torsion spring, so as to change the rotational elastic force of the torsion spring, meet the user's own needs, and greatly improve user experience.

### BRIEF DESCRIPTION OF THE DRAWINGS

FIG. 1 is a 3D diagram of the present disclosure:

FIG. 2 is a schematic partial enlarged diagram of a position A in FIG. 1;

FIG. 3 is a schematic 3D diagram of the present disclosure from another angle;

FIG. 4 is a schematic exploded view of a lower fixing base in the present disclosure;

FIG. 5 is a schematic exploded view of an upper fixing base in the present disclosure;

FIG. 6 is a top view of a rotating drum in the present disclosure;

FIG. 7 is a sectional view of the present disclosure;

FIG. 8 is a schematic partial enlarged diagram of a position B in FIG. 7;

FIG. 9 is a schematic partial enlarged diagram of a position C in FIG. 7;

FIG. 10 is a schematic 3D diagram of a locking device; and

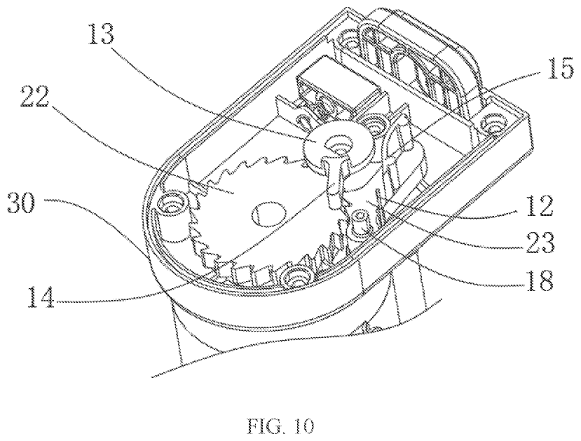

FIG. 11 is a top view of a locking device.

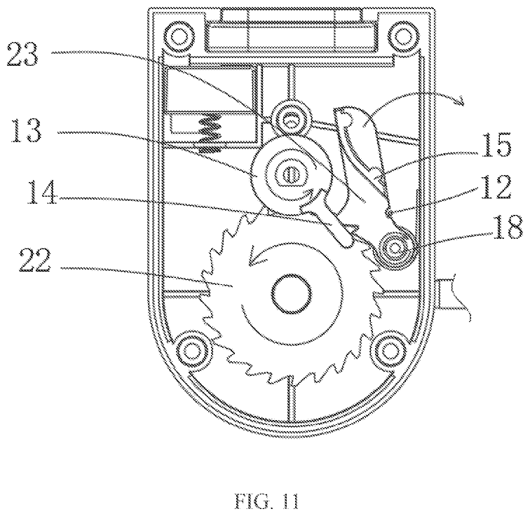

Reference numerals of the accompanying drawings: 10. rotating drum; 11. fixing groove; 20. upper fixing base; 21. locking knob; 22. locking ratchet; 23. locking pawl; 24. placing cavity; 30. lower fixing base; 31. adjusting ratchet; 32. adjusting pawl; 34. unlocking part; 35. first abutment spring; 36. window hole; 37. adjusting groove; 40. partition cloth; 41. protecting shell; 42. corner wrapping part; 43. plastic strip; 50. support rod; 51. movable fixing base; 6. torsion spring; 7. adjusting rod; 8. lower mounting base; 9. limit ring; 25. connecting shaft; 26. upper mounting base; 12. second abutment spring; 13. pushing-away turntable; 14. pushing-away convex portion; 15. pushed-away part; 16. protective shell; 17. sealing cover; 18. rotating shaft; 19. rotating rod.

### DESCRIPTION OF THE EMBODIMENTS

The following clearly and completely describes the technical solutions in the embodiments of the present disclosure with reference to accompanying drawings. Apparently, the described embodiments are merely sonic rather than all of the embodiments. All other embodiments obtained by a person of ordinary skill in the art based on the embodiments of the present disclosure without creative efforts shall fall within the protection scope of the present disclosure.

It should be noted that if directional indications (such as “up”, “down”, “left”, “right”, “front”, “back”, “top”, “bottom”, “inside”, “outside”, “vertical”, “transverse”, “longitudinal”, “counterclockwise”, “clockwise”, “circumferential”, “radial”, “axial”, . . . ) are involved in the embodiments of the present disclosure, the directional indications are only used to explain the relative position relationship and movement situation and the like among components in a specific posture (as shown in the accompanying drawings). If the specific posture changes, the directional indications will change accordingly.

In addition, if there are descriptions related to “first” or “second” or the like in the embodiments of the present disclosure, the descriptions of “first” or “second” or the like are only used for description, and cannot be understood as indicating or implying its relative importance or implicitly indicating the number of indicated technical features. Therefore, the features defined with “first” and “second” may include at least one of the features explicitly or implicitly. In addition, the technical solutions among the various embodiments may be combined with each other, but they must be based on the implementation by a person of ordinary skill in the art. When the combination of technical solutions is contradictory or impossible to implement, it should be considered that the combination of the technical solutions does not exist, nor is it within the protection scope required by the present disclosure.

At present, the retractable door sill on the market is implemented by only setting a torsion spring to a certain torsional deformation and then placing the torsion spring into a rotating drum. A user cannot actively adjust a torsional deformation of the torsion spring during the use of the retractable door sill. The user cannot actively adjust a rotational elastic force of the torsion spring according to his/her own needs when actually using the retractable door sill, so that the user experience is poor.

Therefore, an embodiment of the present disclosure provides a retractable door sill. The retractable door sill according to the present disclosure is provided with an adjusting device, the adjusting device includes an adjusting rod and an adjusting mechanism, one end of the torsion spring is connected to the rotating drum, the other end of the torsion spring is connected to the adjusting rod of the adjusting device, the adjusting mechanism is configured to enable the adjusting rod to rotate unidirectionally around its own axis, and the adjusting rod drives an end of the torsion spring to perform torsion through its own rotation. Moreover, because the adjusting rod only rotates unidirectionally, a torsional deformation of the torsion spring can be changed. Through the aforementioned operations, a user can actively adjust the torsional deformation of the torsion spring, so as to change the rotational elastic force of the torsion spring, meet the users own needs, and greatly improve user experience. The following will be explained and introduced through specific embodiments.

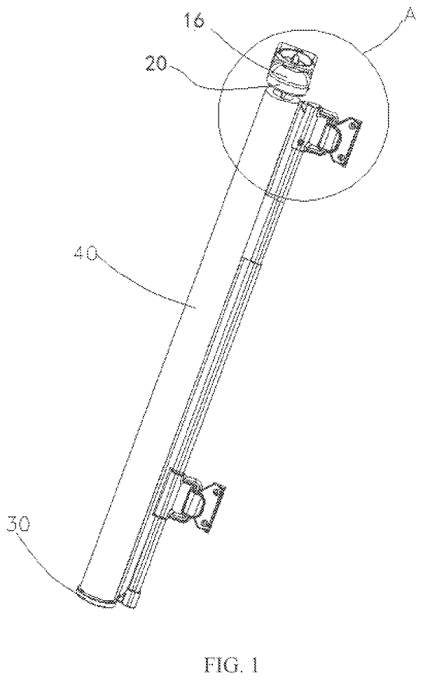

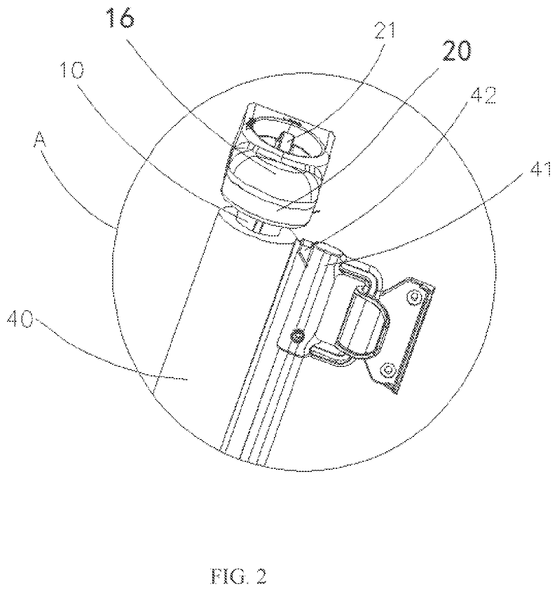

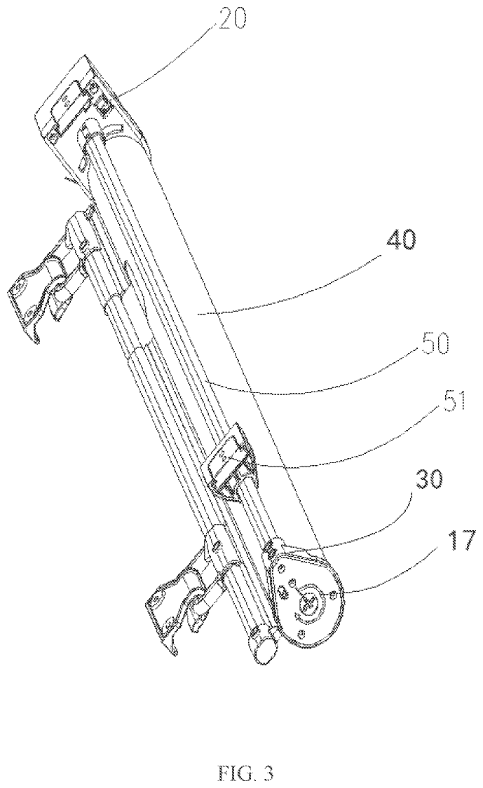

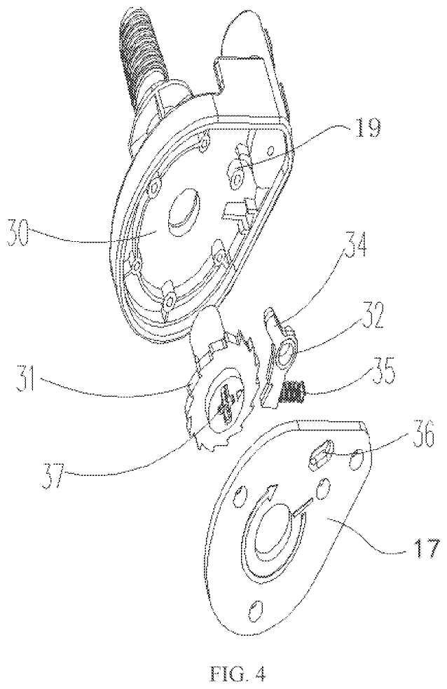

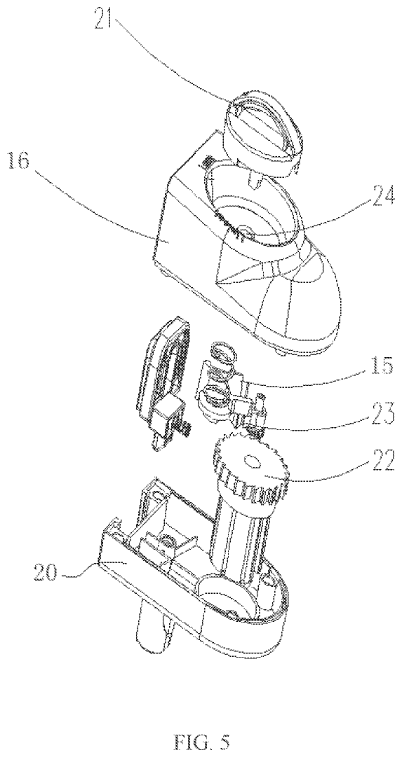

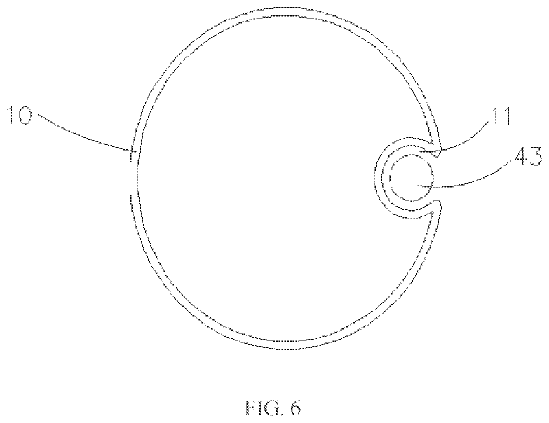

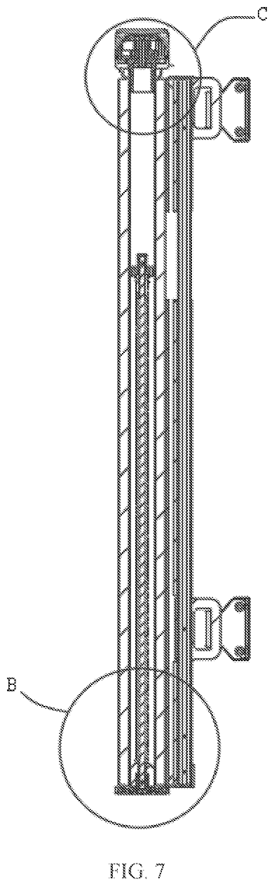

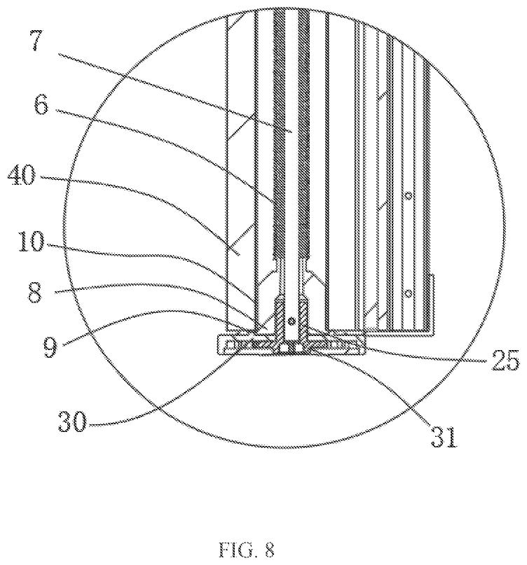

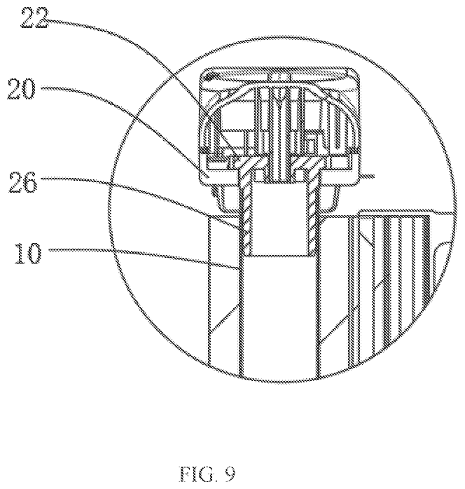

As shown in FIG. 1 to FIG. 9, a retractable door sill includes:

a mounting base;

the mounting base including an upper fixing base 20 and a lower fixing, base 30;

a rotating drum 10, the rotating drum 10 being arranged between the upper fixing base 20 and the lower fixing base 30, and the rotating drum 10 being configured to rotate around its own axis;

a partition cloth 40, an end of the partition cloth 40 being arranged on the rotating drum 10;

a torsion spring 6 being arranged in the rotating drum 10, and the torsion spring 6 being configured to make the rotating drum 10 rotate in one direction around its axis, so that the rotating drum 10 can wind up the partition cloth 40; and

an adjusting device, the adjusting device including an adjusting rod 7 and an adjusting mechanism, and one end of the torsion spring 6 being connected to the rotating drum 10. In this embodiment, a bottom end of the rotating drum 10 is provided with a lower mounting base 8, and the bottom end of the rotating drum 10 is detachably connected to the lower mounting base 8. The lower mounting base 8 is arranged on a limit ring 9 convexly arranged on the lower fixing base 30, i.e., the lower mounting base 8 can rotate around its own axis relative to the lower fixing base 30, and one end of the torsion spring 6 is connected to the lower mounting base 8, so that one end of the torsion spring 6 is connected to the rotating drum 10, and the other end of the torsion spring 6 is connected to the adjusting rod 7 of the adjusting device. The adjusting mechanism is a unidirectional rotating mechanism. The adjusting mechanism is configured to enable the adjusting rod 7 to rotate unidirectionally around its own axis, and the adjusting rod 7 is configured to change a torsional deformation of the torsion spring 6 through its own unidirectional rotation. In this embodiment, the adjusting structure adopts a ratchet mechanism as a unidirectional rotating mechanism. In other embodiments, a user can make other choices according to actual needs, such as selecting a one-way bearing.

The adjusting mechanism is further described below. In this embodiment, the adjusting mechanism includes:

an adjusting ratchet 31;

the adjusting ratchet 31 being connected to the adjusting rod 7;

an adjusting pawl 32 matched with the adjusting ratchet 31, the lower fixing base 30 being provided with an installation cavity, the adjusting ratchet 31 and the adjusting pawl 32 being arranged in the installation cavity, and the adjusting ratchet 31 being configured to be rotatable around its own axis; specifically, a connecting shaft 25 being convexly arranged on the adjusting ratchet 31, the connecting shaft 25 being inserted in a through hole formed in the lower fixing base 30, so that the adjusting ratchet 31 can rotate around its own axis, a rotating rod 19 being convexly arranged on the lower fixing base 30, and the adjusting pawl 32 sleeving the rotating rod 19 through a through hole formed in the adjusting pawl 32; and

a first abutment spring 35, the first abutment spring 35 being configured to push the adjusting pawl 32 to maintain a tendency of inserting into a tooth groove in the adjusting ratchet 31. In this adjusting mechanism, it can be learned that due to the existence of the adjusting pawl 32, the adjusting ratchet 31 can only rotate in one direction around its axis, i.e., it cannot rotate clockwise after rotating counterclockwise. In this embodiment, when twisted, the adjusting ratchet 31 is enabled to rotate counterclockwise, so as to drive the adjusting rod 7 to rotate counterclockwise. The torsion spring 6 is compressed through unidirectional rotation of the adjusting rod 7, thus increasing the torsional deformation of the torsion spring 6 and a torsional elastic force of the torsion spring 6. To facilitate the torsion of the adjusting ratchet 31 by hand with the aid of a tool, an outer side face of the adjusting ratchet 31 may be provided with an adjusting groove 37. In this embodiment, the adjusting groove 37 is in a cross shape, and a common cross screwdriver tool may be used. In other embodiments, a user can make other choices according to actual needs, for example, selecting a screwdriver shaped like.

If the user needs to reduce the torsional deformation of the torsion spring 6 and reduce the torsional elastic force of the torsion spring 6, in an embodiment, an unlocking part 34 is convexly arranged on a side of the adjusting ratchet 32. The unlocking part 34 is pushed by hand and then drives the adjusting pawl 32 to be separated from the tooth groove in the adjusting ratchet 31. When the adjusting pawl 32 does not limit the adjusting ratchet 31, the adjusting ratchet 31 does not apply force to the torsion spring 6 through the adjusting rod 7, the torsion spring 6 recovers to its original state after the external force is removed, the torsional deformation of the torsion spring 6 gradually decreases, and the torsional elastic force of the torsion spring 6 gradually decreases. When the unlocking part 34 is released by hand, so that the unlocking part 34 is in a freely movable state, the first abutment spring 35 can re-push the adjusting pawl 32 to be inserted into a tooth groove in the adjusting ratchet 31, thus preventing the torsion spring 6 from continuing to reduce the torsional deformation. Through the description of the above-mentioned structure, action process and manual operation method, it can be learned that the adjusting structure increases the torsional deformation of the torsion spring 6 by using basic characteristics of unidirectional rotation of the ratchet mechanism, and reduces the torsional deformation of the torsion spring 6 by using the characteristic that the torsion spring 6 recovers itself after the external force is removed, thereby meeting requirements that the user can actively adjust the torsional deformation of the torsion spring 6.

In this embodiment, a lower end face of the lower fixing base 30 is provided with a sealing cover for sealing the installation cavity, and the sealing cover is provided with a window hole 36 for making the unlocking part 34 visible. The unlocking part 34 in the installation cavity can be operated through the window hole 36.

When the user pulls the partition cloth 40 from the rotating drum 10 by a certain length, the position of the partition cloth 40 needs to be locked to prevent the partition cloth 40 from being further pulled out of the rotating drum 10. This may be done by means of a locking device. The structure of the locking device is further explained below. In this embodiment, the locking device is arranged in the upper fixing base 20, and the includes:

a locking ratchet 22;

the locking ratchet 22 being connected to an upper end of the rotating drum 10, where in this embodiment, an upper mounting base 26 is convexly arranged on the locking ratchet 22; the upper mounting base 26 passes through a through hole formed in the upper fixing base 20; the upper mounting base 26 can rotate around its own axis relative to the upper fixing base 20, and the rotating drum 10 may be configured to be rotatable around its own axis through the upper mounting base 26 and the lower mounting base 8 arranged at a bottom end of the rotating drum 10;

a locking pawl 23 matched with the locking ratchet 22, a rotating, shaft 18 being convexly arranged on the upper fixing base 20, and the locking pawl 23 sleeving the rotating shaft 18 through a through hole formed in the locking pawl; and

a second abutment spring 12, the second abutment spring 12 being configured to push the locking pawl 23 to maintain a tendency of inserting into a tooth groove in the locking ratchet 22.

In this locking device, it can be learned that due to the limitation from the locking pawl 23, the locking ratchet 22 can only rotate in one direction around its own axis, i.e., it cannot rotate clockwise after rotating counterclockwise. In this embodiment, when the locking pawl 23 is not inserted into a tooth groove in the locking ratchet 22, the partition cloth 40 can be pulled out from the rotating drum 10. At this time, the rotating drum 10 rotates clockwise, the locking ratchet 22 also rotates clockwise, and the locking pawl 23 does not limit the rotation of the locking ratchet 22. When the partition cloth 40 needs to be locked so as to be prevented from being further pulled out, the second abutment spring 12 can be used to drive the locking pawl 23 to be inserted into a tooth groove in the locking ratchet 22, the locking pawl 23 limits the locking ratchet 22 so that the locking ratchet 22 cannot continue to rotate clockwise, and thus the partition cloth 40 cannot be further pulled out. It should be noted that at this time, the locking pawl 23 does not limit the counterclockwise rotation of the locking ratchet 22, and the torsional elastic force of the torsion spring 6 always applies a winding force to the partition cloth 40. Although the partition cloth 40 is prevented from being further pulled out, it can be kept in a tight state.

If the user needs to unlock the above-mentioned partition cloth 40, an unlocking assembly may be used. The structure of the unlocking assembly will be further explained below. In this embodiment, the unlocking assembly includes a pushing-away turntable 13 and a pushing-away convex portion 14 arranged on a side of the pushing-away turntable 13, and the pushing-away turntable 13 is configured to be rotatable around its own axis; and

a pushed-away part 15 is convexly arranged on the locking pawl 23, the pushing-away convex portion 14 is configured to be driven to rotate around the axis of the pushing-away turntable 13, so that the pushing-away convex portion 14 pushes the pushed-away part 15 to make the pushed-away part 15 rotate around an axis of the rotating shaft 18, and thus the locking pawl 23 is driven by the pushed-away part 15 to be separated from the tooth groove in the locking ratchet 22, thereby unlocking the partition cloth 40.

In this embodiment, the upper fixing base 20 is provided with a protective shell 16, the protective shell 16 is provided with a placing cavity 24 capable of accommodating a locking knob 21, and to facilitate the user's operation on the pushing-away convex portion 14, the locking knob 21 is connected to the pushing-away turntable 13.

In this embodiment, a pull-out end cover of the partition cloth 40 is provided with a protecting shell 41, the protecting shell 41 is provided with a corner wrapping part 42, and the corner wrapping part 42 is configured to wrap a corner of a pulled-out end of the partition cloth 40. The protecting shell 41 is arranged to protect the pulled-out end of the partition cloth 40, so that the service life of the partition cloth 40 is effectively prolonged. Because a corner of the partition cloth 40 is easily damaged during use, the protecting shell 41 is provided with a corner wrapping part 42 to wrap and protect the corner of the partition cloth 40 so as to protect the corner of the partition cloth 40 from damage after use for many times, and further prolong the service life of a cloth body.

In this embodiment, the rotating drum 10 is provided with a fixing groove 11, a length direction of the fixing groove 11 is flush with the axis of the rotating drum 10, a plastic strip 43 is connected to an end of the partition cloth 40 arranged on the rotating drum 10, and the plastic strip 43 is clamped in the fixing groove 11, so that the partition cloth 40 is fixedly connected to the rotating drum 10.

The lower fixing base 30 has a thickness of 5 mm to 10 mm. In this embodiment, the lower fixing base 30 has a thickness of 8 mm, which greatly reduces a distance between the bottom of the partition cloth 40 and the ground, effectively prevents insects such as crawlers from crawling under the partition cloth 40, and effectively intercepts the insects.

In addition, a support rod 50 parallel to the rotating drum 10 is arranged between the upper fixing base 20 and the lower fixing base 30, and a movable fixing base 51 is arranged at the support rod 50. The movable fixing base 51 can move back and forth in the length direction of the support rod 50. When the retractable door sill is installed, since there is only an upper fixing point and a lower fixing point, the stability in the middle will be insufficient and the retractable door sill is damaged easily. After the movable fixing base 51 is provided, the middle part of the retractable door sill can be fixedly supported, thereby improving the stability of the installation.

The above are only preferred embodiments of the present disclosure, and are not intended to limit the patent scope of the present disclosure. Under the inventive concept of the present disclosure, equivalent structural transformations made by using the contents of the specification and accompanying drawings of the present disclosure are directly/indirectly applied in other related technical fields and shall fall within the patent protection scope of the present disclosure.

What is claimed is:

1. A retractable door sill, comprising:
a mounting base;
the mounting base comprising an upper fixing base and a lower fixing base;
a rotating drum, the rotating drum being arranged between the upper fixing base and the lower fixing base, and the rotating drum being configured to rotate around its own axis;
a partition cloth, an end of the partition cloth being arranged on the rotating drum;
a torsion spring being arranged in the rotating drum, and the torsion spring being configured to make the rotating drum rotate in one direction around its axis, so that the rotating drum can wind up the partition cloth; and
a support rod parallel to the rotating drum is arranged between the upper fixing base and the lower fixing base, and a movable fixing base is arranged at the support rod; the movable fixing base can move back and forth in the length direction of the support rod.

2. The retractable door sill according to claim 1, further comprising an adjusting device, the adjusting device comprising an adjusting rod and an adjusting mechanism, one end of the torsion spring being connected to the rotating drum, the other end of the torsion spring being connected to the adjusting rod of the adjusting device, the adjusting mechanism being a unidirectional rotating mechanism, the adjusting mechanism being configured to enable the adjusting rod to rotate unidirectionally around its own axis, and the adjusting rod being configured to drive the torsion spring to twist through its own unidirectional rotation to complete the compression of the torsion spring, so as to increase the torsional deformation of the torsion spring.

3. The retractable door sill according to claim 2, wherein the adjusting mechanism comprises:
an adjusting ratchet;
the adjusting ratchet being connected to the adjusting rod;
an adjusting pawl matched with the adjusting ratchet, the lower fixing base being provided with an installation cavity, the adjusting ratchet and the adjusting pawl being arranged in the installation cavity, the adjusting ratchet being configured to be rotatable around its own axis, a rotating rod being convexly arranged on the lower fixing base, and the adjusting pawl sleeving the rotating rod through a through hole formed in the adjusting pawl; and
a first abutment spring, the first abutment spring being configured to push the adjusting pawl to maintain a tendency of inserting into a tooth groove in the adjusting ratchet.

4. The retractable door sill according to claim 3, wherein an outer side face of the adjusting ratchet is provided with an adjusting groove.

5. The retractable door sill according to claim 3, wherein an unlocking part is convexly arranged on a side of the adjusting ratchet, and configured to drive the adjusting pawl to be separated from the tooth groove in the adjusting ratchet after being pushed.

6. The retractable door sill according to claim 5, wherein a lower end face of the lower fixing base is provided with a sealing cover for sealing, the installation cavity, and the sealing cover is provided with a window hole for making the unlocking part visible.

7. The retractable door sill according to claim 1, further comprising a locking device, wherein the locking device is arranged in the upper fixing base, and comprises:
a locking ratchet;
the locking ratchet being connected to an upper end of the rotating drum;
a locking pawl matched with the locking ratchet, a rotating shaft being convexly arranged on the upper fixing base, and the locking pawl sleeving the rotating shaft through a through hole formed in the locking pawl; and
a second abutment spring, the second abutment spring being configured to push the locking pawl to maintain a tendency of inserting into a tooth groove in the locking ratchet.

8. The retractable door sill according to claim 7, wherein the locking device further comprises an unlocking assembly, wherein
the unlocking assembly comprises a pushing-away turntable and a pushing-away convex portion arranged on a side of the pushing-away turntable, and the pushing-away turntable is configured to be rotatable around its own axis; and
a pushed-away part is convexly arranged on the locking pawl, the pushing-away convex portion is configured to be driven to rotate around the axis of the pushing-away turntable, so that the pushing-away convex portion pushes the pushed-away part to make the pushed-away part rotate around an axis of the rotating shaft, and thus the locking pawl is driven by the pushed-away part to be separated from the tooth groove in the locking ratchet.

9. The retractable door sill according to claim 8, wherein the upper fixing base is provided with a protective shell, the protective shell is provided with a placing cavity capable of accommodating a locking knob, and the locking knob is connected to the pushing-away turntable.

10. The retractable door sill according to claim 1, wherein a pull-out end cover of the partition cloth is provided with a protecting shell, the protecting shell is provided with a corner wrapping part, and the corner wrapping part is configured to wrap a corner of a pulled-out end of the partition cloth.

11. The retractable door sill according to claim 1, wherein the rotating drum is provided with a fixing groove, a length direction of the fixing groove is flush with the axis of the rotating drum, a plastic strip is connected to an end of the partition cloth arranged on the rotating drum, and the plastic strip is clamped in the fixing groove.
